(19) United States
(12) Patent Application Publication
(10) Pub. No.: US 2021/0047874 A1
(43) Pub. Date: Feb. 18, 2021

(54) ACCESS CONTROL DEVICE

(71) Applicants: CRUCIALTEC CO.LTD, Seongnam-si Gyeonggi-do (KR); CRUCIALTRAK, INC, Seongnam-si Gyeonggi-do (KR)

(72) Inventors: Yong Hee HAN, Gwangju-si, Gyeonggi-do (KR); Dong Hyun OH, Seoul (KR); Dong Ho LEE, Seongnam-si, Gyeonggi-do (KR)

(21) Appl. No.: 16/628,944

(22) PCT Filed: Jun. 25, 2018
(86) PCT No.: PCT/KR2018/007149

§ 371 Date: Jan. 6, 2020

(30) Foreign Application Priority Data
Jul. 4, 2017 (KR) 10-2017-0084586

(51) Int. Cl. E05F 15/632; E05F 15/73; E05F 17/00; G07C 9/25

(52) U.S. Cl. CPC E05F 15/632; E05F 15/73; E05F 17/002; E05Y 2900/40; E05F 2017/007; E05Y 2800/122; E05Y 2900/132; G07C 9/25

(57) ABSTRACT

Disclosed is an access control apparatus according to the present invention. The access control apparatus includes: a body located on a passage; an opening and closing part coupled to the body and having a multi-stepped door adapted to open and close the passage through a translational motion; and a driving part coupled to the body and the opening and closing part to control an operation of the opening and closing part, wherein the driving part has a linear motor and the multi-stepped door includes a first door driven by means of the linear motor and a second door coupled to the first door in such a manner as to be interlocked with the first door.

### TECHNICAL FIELD

The present invention relates to an access control apparatus, and more particularly, to an access control apparatus that is capable of achieving an improvement in durability and an adjustment in installation width through a linear motor and a multi-stepped door.

### BACKGROUND ART

An access control apparatus is generally located on an entrance side of a building or subway station so as to admit accesses to only persons having a given requirement for the access to the building or subway station. The access control apparatus is called access gates. Generally, the access gate is operated to allow a door (opening and closing part) to be open if a security card of a user comes into contact therewith. Recently, an access gate has been developed to allow a door to be open through biological identification information like a user's finger print.

Examples of the access gate include a turn type gate, a slide type gate, a swing type gate, and so on.

The turn type gate has a plurality of bars mounted thereon in such a manner as to be rotatable by a shaft. The turn type gate has an advantage like a low installation cost, but inconveniently, users have to directly push the bars so as to pass through the gate. Also, the swing type gate is configured to have a door rotating around a rotary shaft, so that a user may collide against the door, thereby undesirably causing safety problems. Accordingly, the slide type gate with an automatically sliding door, which is more advantageous in safety than the swing type gate, has been widely used.

One of main standards for estimating the performance of the access gate is a handling capacity. The handling capacity of the access gate is determined according to a driving speed of the door (opening and closing part) and a size of the gate. If the driving speed of the door is fast, in detail, the number of persons passing through the gate within given time can be increased, and if the size of the gate is small, a plurality of access gates can be located within a restricted area, thereby increasing the number of persons passing through the gates.

Also, the durability of the access gate, especially, the durability of the door (opening and closing part) has a big influence on the maintenance cost of the access gate, and accordingly, the durability of the access gate becomes one of the standards for estimating the performance of the access gate. If the door is repaired because of its failure, the handling capacity of the access gate becomes greatly decreased.

FIG. 1 is a sectional view showing a conventional slide type gate. As shown in FIG. 1, the conventional slide type gate is configured to have a given sized door (opening and closing part) D inserted into a body B. As a result, a width of the body B is equal to or larger than a width of the door D, which causes a limitation in reducing the width of the body B. Further, there is a limitation in increasing a driving speed of the door D due to a structure in which the door D slides to left and right sides.

As mentioned above, also, the conventional slide type gate is configured to have the given sized door coupled to the body, thereby making it impossible to freely adjust the installation width thereof.

Further, the conventional slide type gate is configured to drive a link 20 through a rotary motor 50 so as to control the door D (opening and closing part). In detail, the conventional slide type gate additionally requires pulleys 32 and 32′ and the link 20 so as to slide the door D (opening and closing part) through the rotary motor 50, thereby causing over load to be applied to the rotary motor 50. According to the conventional slide type gate, therefore, the life span of the rotary motor 50 becomes shortened to cause the durability of the entire slide type gate to be deteriorated.

Accordingly, there is a need for development of a new slide type gate structure capable of solving such technical problems occurring in the art.

(Patent Document 1) Korean Patent No. 10-0796273 (entitled ‘Access apparatus for ticket gate operated simultaneously by belt’)

### DISCLOSURE

### Technical Problem

Accordingly, the present invention has been made in view of the above-mentioned problems occurring in the related art, and it is an object of the present invention to provide an access control apparatus that is capable of providing a faster driving speed of an opening and closing part than that of a conventional slide type gate and more excellent durability than the conventional slide type gate.

It is another object of the present invention to provide an access control apparatus that is capable of reducing an installation width thereof and increasing a handling capacity thereof. The technical problems to be achieved through the present invention are not limited as mentioned above, and other technical problems not mentioned herein will be obviously understood by one of ordinary skill in the art through the following description.

### Technical Solution

To accomplish the above-mentioned objects, according to one aspect of the present invention, there is provided an access control apparatus including: a body located on a passage; an opening and closing part coupled to the body and having a multi-stepped door adapted to open and close the passage through a translational motion; and a driving part coupled to the body and the opening and closing part to control an operation of the opening and closing part, wherein the driving part has a linear motor and the multi-stepped door includes a first door driven by means of the linear motor and a second door coupled to the first door in such a manner as to be interlocked with the first door.

According to the present invention, desirably, the body includes a support frame having an accommodation space adapted to allow the opening and closing part and the driving part to be detachably attached or inserted thereinto. According to the present invention, desirably, the opening and closing part and the driving part are coupled to each other to constitute an integral type unit, and the integral type unit is inserted into the accommodation space.

According to the present invention, desirably, a plurality of integral type units is provided.

According to the present invention, desirably, the linear motor controls the first door so that the first door slides on the accommodation space.

According to the present invention, desirably, the driving part further includes a second door driving module for surrounding the second door to control the second door so that the second door slides on the first door.

According to the present invention, desirably, the second door driving module includes a power transmission unit and slides the second door on the first door through the power transmission unit.

According to the present invention, desirably, if the opening and closing part is closed by means of the driving part, the linear motor controls the first door in such a manner as to allow the first door to slide toward the outside of the accommodation space, while the second door driving module is controlling the second door in such a manner as to allow the second door to slide toward the outside of the first door, and if the opening and closing part is open by means of the driving part, the linear motor controls the first door in such a manner as to allow the first door to slide toward the inside of the accommodation space, while the second door driving module is controlling the second door in such a manner as to allow the second door to slide toward the inside of the first door.

According to the present invention, desirably, a first door control event in which the linear motor slides the first door on the accommodation space and a second door control event in which the second door driving module slides the second door on the first door occur simultaneously, and otherwise, one of the first door control event and the second door control event occurs before the other control event occurs.

According to the present invention, desirably, the access control apparatus further includes a recognizing part located on one side thereof and having at least one or more modules selected from a finger print recognizing module for recognizing the finger print of the user of the access control apparatus, a vein recognizing module for recognizing the vein shape of the user of the access control apparatus, an iris recognizing module for recognizing the iris of the user of the access control apparatus, and a face recognizing module for recognizing the facial shape of the user of the access control apparatus so as to recognize the user of the access control apparatus, so that if the recognized user of the access control apparatus is an access-admitted person, the access control apparatus opens the opening and closing part by means of the driving part.

According to the present invention, desirably, the access control apparatus further includes a guiding part adapted to guide the use of the access control apparatus and having a first sensing module disposed on one end of the support frame to sense one user of the access control apparatus, a second sensing module disposed on the other end of the support frame symmetrical to one end of the support frame to sense the other user of the access control apparatus, and an access guiding module for guiding access to the access control apparatus, so that if any one of the first sensing module and the second sensing module senses one user, the guiding part guides the sensed user to the access control apparatus through the access guiding module, and if both of the first sensing module and the second sensing module sense the users, the guiding part guides the first sensed user in the sensed order to the access control apparatus through the access guiding module or guides the closer user on the basis of the sensed distance to the access control apparatus through the access guiding module.

According to the present invention, desirably, the access guiding module provides first access to the access control apparatus for one user or the other user by means of lighting of LEDs toward one user or the other user or guide one user and the other user to different ways.

To accomplish the above-mentioned objects, according to another aspect of the present invention, there is provided an access control system including the plurality of access control apparatuses according to one aspect of the present invention, wherein the plurality of access control apparatuses is spaced apart from each other by given distances.

### Advantageous Effects

According to the present invention, the access control apparatus can reduce a width of the body through the multi-stepped door capable of sliding doubly and increase a handling capacity thereof.

In addition, the access control apparatus according to the present invention can improve a driving speed of the opening and closing part through the linear motor and increase the durability of the driving part, thereby enhancing durability, reliability, and economical effects thereof.

Further, the access control apparatus according to the present invention can be provided with the recognizing part capable of performing recognition for finger print, vein shape, iris shape, and facial shape, thereby enhancing a security level of the access control apparatus and making it unnecessary to use a security card upon the access to the access control apparatus.

Furthermore, the access control apparatus according to the present invention can be provided with the guiding part capable of indicating first access to one user among a plurality of users or guiding the plurality of users to different ways.

The effects of the invention are not limited as mentioned above, and it should be understood that the effects of the invention include all effects inferable from the detailed description and claims of the present invention.

### DESCRIPTION OF DRAWINGS

FIG. 1 is a sectional view showing a conventional slide type gate.

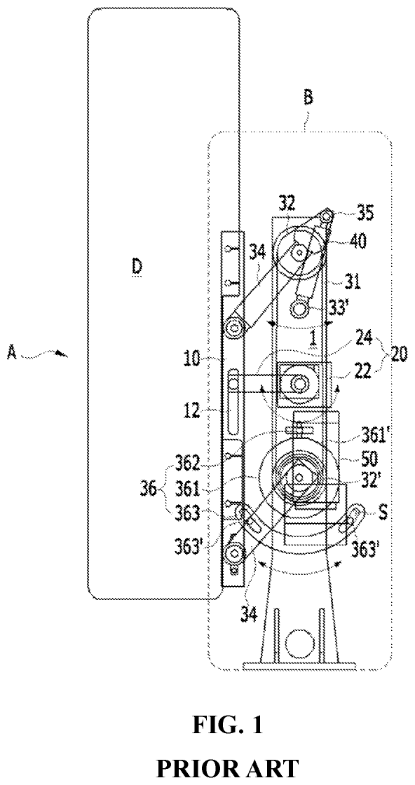

FIG. 2 is a block diagram showing a configuration of an access control apparatus according to the present invention.

FIG. 3 is a schematic perspective view showing an outer appearance of the access control apparatus according to the present invention.

FIGS. 4A and 4B are front views showing various examples of a body of the access control apparatus according to the present invention.

FIG. 5 is a perspective view showing a detailed configuration of an opening and closing part of the access control apparatus according to the present invention.

FIG. 6 is a sectional view showing a closing mode of the opening and closing part of the access control apparatus according to the present invention.

FIG. 7 is a sectional view showing an opening mode of the opening and closing part of the access control apparatus according to the present invention.

FIG. 8 is a perspective view showing a detailed configuration of a recognizing part of the access control apparatus according to the present invention.

FIG. 9 is a side view showing a detailed configuration of a guiding part of the access control apparatus according to the present invention.

FIG. 10 is a perspective view showing an access control system having the plurality of access control apparatuses according to the present invention.

### MODE FOR INVENTION

Hereinafter, the present invention will be in detail explained with reference to the attached drawings.

The present invention may be modified in various ways and may have several exemplary embodiments. The following drawings herein illustrate preferred embodiments of the present invention and serve to facilitate the general understanding of the scope of the present invention, together with the detailed description of the present invention. Therefore, the present invention is not limitedly interpreted only with the attached drawings. However, it should be understood that the invention covers all the modifications, equivalents, and replacements within the idea and technical scope of the invention. In order to facilitate the general understanding of the present invention in describing the present invention, through the accompanying drawings, the same reference numerals will be used to describe the same components and an overlapped description of the same components will be omitted.

The term ‘modules’, and ‘parts’, as used herein, are used only for the description of the present invention, and therefore, they do not have any distinguishing meaning or roles. If it is determined that the detailed explanation on the well known technology related to the present invention makes the scope of the present invention not clear, the explanation will be avoided for the brevity of the description.

In the description, when it is said that one element is described as being “connected” or “coupled” to the other element, one element may be directly connected or coupled to the other element, but it should be understood that another element may be present between the two elements. When it is said that one portion is described as “includes” any component, further, one element further may include other components unless no specific description is suggested.

Terms used in this application are used to only describe specific exemplary embodiments and are not intended to restrict the present invention. An expression referencing a singular value additionally refers to a corresponding expression of the plural number, unless explicitly limited otherwise by the context. In this application, terms, such as “comprise”, “include”, or “have”, are intended to designate those characteristics, numbers, steps, operations, elements, or parts which are described in the specification, or any combination of them that exist, and it should be understood that they do not preclude the possibility of the existence or possible addition of one or more additional characteristics, numbers, steps, operations, elements, or parts, or combinations thereof.

Terms, such as the first, the second, A, and B, may be used to describe various elements, but the elements should not be restricted by the terms. The terms are used to only distinguish one element from the other element. For example, a first element may be named a second element without departing from the scope of the present invention. Likewise, a second element may be named a first element.

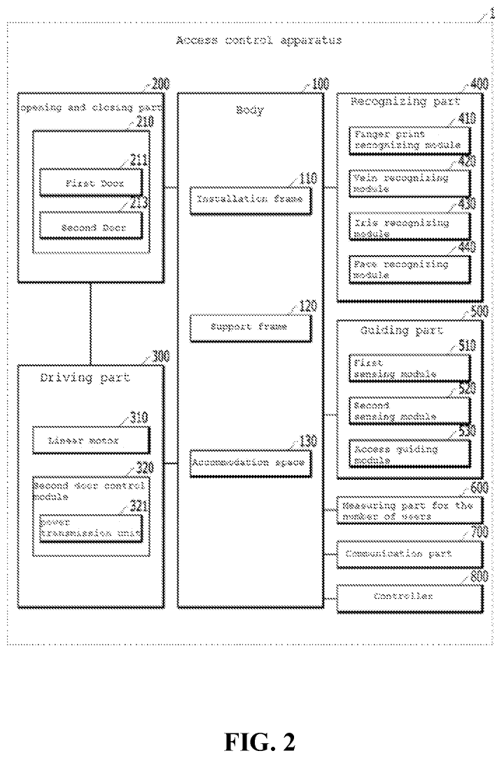

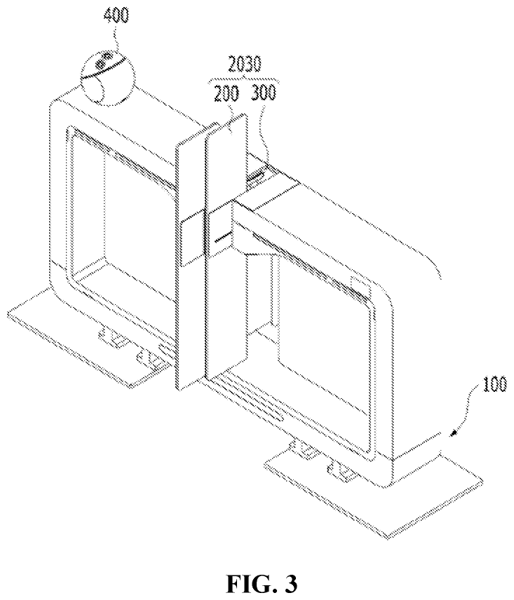

FIG. 2 is a block diagram showing a configuration of an access control apparatus according to the present invention, and FIG. 3 is a schematic perspective view showing an outer appearance of the access control apparatus according to the present invention.

An access control apparatus 1 for controlling a passage includes a body 100, an opening and closing part 200, and a driving part 300, and further, the access control apparatus 1 includes a recognizing part 400, a guiding part 500, a measuring part 600 for the number of users, a communication part 700. Additionally, the access control apparatus 1 includes power (not shown), a battery (not shown), and a speaker (not shown).

The body 100 is located on the passage to form an outer appearance of the access control apparatus 1 and serves to support, protect and accommodate the respective parts of the access control apparatus 1.

The opening and closing part 200 is coupled to the body 100 and has a multi-stepped door 210 doubly slidable, so that the opening and closing part 200 serves to open and close the passage through changes to an opening mode and a closing mode.

The driving part 300 is coupled to the body 100 and the opening and closing part 200 and serves to drive the opening and closing part 200 and thus to control an operation of the opening and closing part 200. Further, the opening and closing part 200 and the driving part 300 are coupled to each other to constitute an integral type unit 2030.

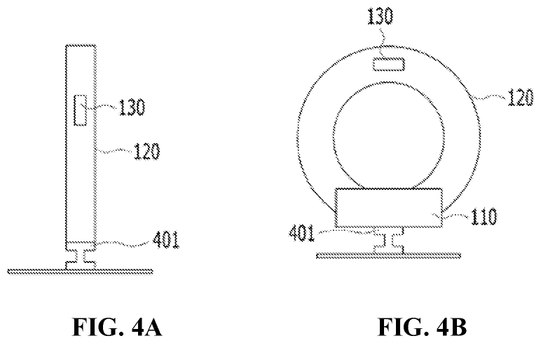

FIGS. 4A and 4B are front views showing various examples of the body 100 of the access control apparatus according to the present invention. Now, the body 100 will be explained in detail with reference to FIGS. 4A and 4B.

The body 100 includes an installation frame 110, a support frame 120, and an accommodation space 130.

The installation frame 110 is located on the floor of the passage, and the support frame 120 is located independently on the passage. Otherwise, the support frame 120 is coupled to the installation frame 110 located on the passage to support the whole access control apparatus 1. Further, the accommodation space 130 is formed on one surface of the body 100 to provide a seating space in which the opening and closing part 200 and the driving part 300 are coupled to the body 100.

As shown in FIG. 4A, if the support frame 120 is located independently on the passage or a separate support 401 installed on the passage, the installation frame 110 is not a necessary part of the access control apparatus 1.

However, as shown in FIG. 4B, if the support frame 120 has a circular structure or cannot be installed on independently on the passage or the support 401, the installation frame 110 is first located on the passage or the support 410 and the support frame 120 is then coupled to the installation frame 110.

As shown in FIGS. 4A and 4B, the structures and shapes of the installation frame 110, the support frame 120, and the accommodation space 130 can be freely changed, without any limitation therein. The support frame 120 has a vertical structure as shown in FIG. 4A or a circular structure as shown in FIG. 4B, but of course, the support frame 120 is not necessarily limited thereto.

Further, one or more accommodation spaces 130 may be formed on the body 100. For example, the accommodation spaces 130 are formed symmetrically around the support frame 120 on both surfaces of the support frame 120.

Accordingly, two accommodation spaces 130 are formed on one support frame 120, and the opening and closing part 200 and the driving part 300 can be detachably attached or inserted into each accommodation space 130.

Also, the accommodation spaces 130 are formed inside the support frame 120 to provide seating spaces in which the opening and closing parts 200 and the driving parts 300 can be detachably attached or inserted.

When the opening and closing part 200 and the driving part 300 are simultaneously inserted into the accommodation space 130, further, they are coupled to each other to constitute the integral type unit 2030 so as to improve spatial efficiencies.

The access control apparatus 1 may have one or more integral type units 2030.

The accommodation space 130 is adapted to allow a portion or whole of the integral type unit 2030 made by coupling the opening and closing part 200 and the driving part 300 to each other to be detachably attached or inserted thereinto. Accordingly, the accommodation space 130 can be freely set in size, which allows the width of the support frame 120 in which the accommodation space 130 is formed to be freely set.

If the accommodation space 130 is formed on the interior or one surface of the support frame 120, the entire size of the access control apparatus 1 can be reduced. Through such a configuration of the access control apparatus 1, accordingly, the number of access control apparatuses 1 to be built in a restricted space can be increased, thereby increasing the number of users using an access control system having a plurality of access control apparatuses 1 within the same time.

Also, the opening and closing part 200 and the driving part 300 can constitute the integral type unit 2030, and the integral type unit 2030 can be detachably attached or inserted into the accommodation space 130. Further, the body 100, the opening and closing part 200, the driving part 300, and their components can be coupled to each other. Accordingly, conveniences in installation and exchange of the parts of the access control apparatus 1 can be improved.

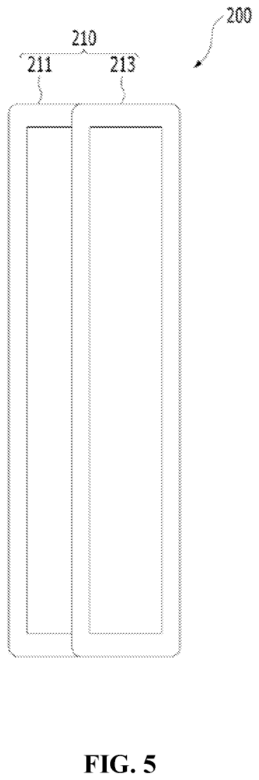

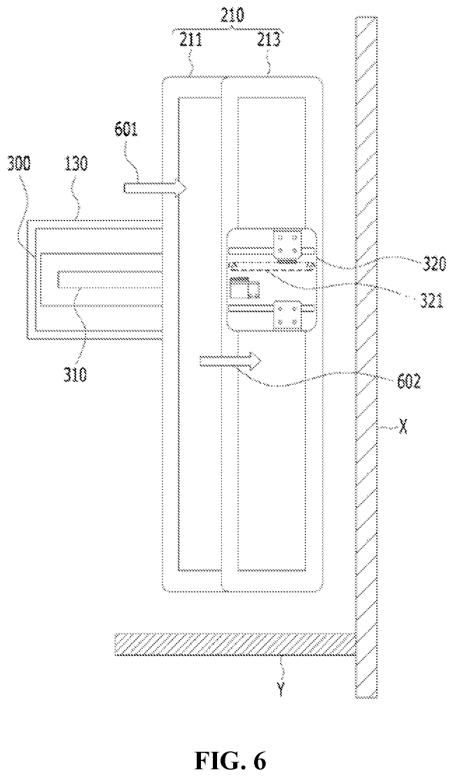

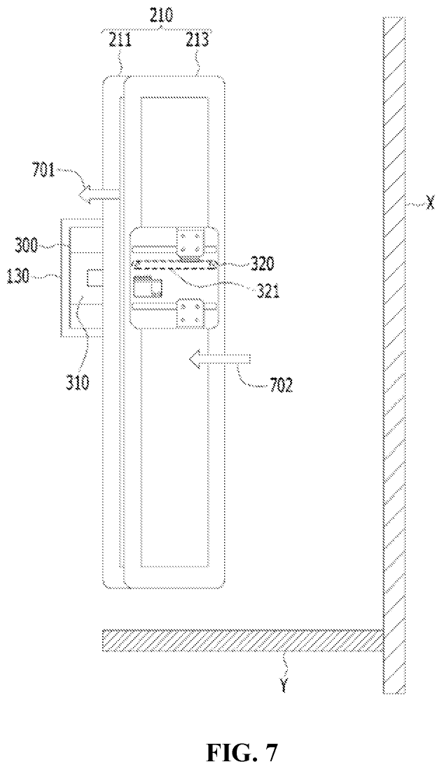

FIG. 5 is a perspective view showing a detailed configuration of the opening and closing part 200 of the access control apparatus according to the present invention, FIG. 6 is a sectional view showing a closing mode of the opening and closing part 200 of the access control apparatus according to the present invention, and FIG. 7 is a sectional view showing an opening mode of the opening and closing part 200 of the access control apparatus according to the present invention. Now, an explanation on a configuration of the opening and closing part 200 and an opening and closing operation of the opening and closing part 200 through the driving part 300 in the access control apparatus 1 according to the present invention will be given in detail with reference to FIGS. 2 to 7.

Referring first to FIGS .2 and 6, the driving part 300 includes a linear motor 310.

A general linear motor is applied to a magnetic levitation train and has a structure in which an induction motor is moved on a plane incised along a shaft. The linear motor has a reaction rail like a stator so as to generate a linear driving force in a direction of the rail.

As mentioned above, the driving part 300 serves to control the operation of the opening and closing part 200 through the linear motor 310, and in detail, the driving part 300 can perform a translational motion for the opening and closing part 200 by means of the characteristics of the linear motor 310 when the opening and closing part 200 is changed to the opening or closing mode.

The translational motion means a motion in which all particles in the system of particles are translationally moved to the same displacement as each other, which is opposite to a rotational motion, and also, the translational motion is called a rectilinear motion.

Since the conventional slide type gate makes use of the rotary motor, the door cannot be translationally moved, and it performs a curvilinear motion or rotational motion. If the door of the slide type gate performs the curvilinear motion or rotational motion, as mentioned above, durability of the slide type gate becomes deteriorated, and accordingly, the access control apparatus 1 according to the present invention is configured to allow the opening and closing part 200 to be translationally moved through the linear motor 310.

As the linear motor 310 makes use of magnetism, further, no separate contact part is needed upon application of power. Accordingly, there is no need to worry about the loss of durability due to the friction of the linear motor 310. Under such a configuration, the access control apparatus 1 can improve durability and increase the opening and closing speed of the opening and closing part 200.

Next, the multi-stepped door 210 of the opening and closing part 200 includes a first door 211 driven by means of the linear motor 310 and a second door 213 coupled to the first door 211 in such a manner as to be interlocked with the first door 211.

In detail, the multi-stepped door 210 includes the first door 211 coupled to the driving part 300 and the second door 213 coupled to the first door 211 in such a manner as to be laid on top of the first door 211.

The sizes and shapes of the first door 211 and the second door 213 are the same as each other, but of course, they may be different from each other. The first door 211 and the second door 213 have a shape of a rectangular panel, but of course, they are not necessarily limited thereto.

The access control apparatus 1 is provided with the stepped door 210 having the first door 211 and the second door 213, so that the sizes of the support frame 120 and the accommodation space 130 can be reduced. Accordingly, the access control apparatus 1 can decrease the whole size thereof and the installation width thereof.

In addition to the linear motor 310, the driving part 300 includes a second door driving module 320.

In detail, the linear motor 310 is coupled to the first door 211 and controls the first door 211 in such a manner as to allow the first door 211 to slide on the accommodation space 130.

So as to perform the double sliding as mentioned above, the second door driving module 320 surrounds the second door 213 and controls the second door 213 in such a manner as to allow the second door 213 to slide on the first door 211.

Further, the second door driving module 320 additionally has a power transmission unit 321 adapted to allow the second door 213 to slide on the first door 211.

Furthermore, the power transmission unit 321 has a belt type power transmission structure. Through the belt type power transmission structure, accordingly, the power transmission unit 321 can allow the second door 213 to naturally slide on the first door 211 in a pulley way.

The multi-stepped door 210 having the double sliding structure can improve spatial efficiencies and provide various opening and closing ways for the opening and closing part 200.

Even if not shown, a third door and a fourth door may be laid on tops of the second door and the third door to make a multiple sliding structure. If the multiple sliding structure is made through the doors laid on tops of each other, the spatial efficiencies of the access control apparatus 1 can be more improved.

Next, an explanation on the closing and opening modes of the opening and closing part 200 having the multi-stepped door 210 capable of doubly sliding will be in detail given.

If the opening and closing part 200 is closed by means of the driving part 300, as shown by an arrow 601 in FIG. 6, the linear motor 310 controls the first door 211 in such a manner as to allow the first door 211 to slide toward the outside of the accommodation space 130 (in an outward direction of the accommodation space 130), and also, as shown by an arrow 602 in FIG. 6, the second door driving module 320 controls the second door 213 in such a manner as to allow the second door 213 to slide toward the outside of the first door 211 (in a direction toward a wall X in FIG. 6).

If the opening and closing part 200 is open by means of the driving part 300, as shown by an arrow 701 in FIG. 7, the linear motor 310 controls the first door 211 in such a manner as to allow the first door 211 to slide toward the inside of the accommodation space 130, and also, as shown by an arrow 702 in FIG. 7, the second door driving module 320 controls the second door 213 in such a manner as to allow the second door 213 to slide toward the inside of the first door 211 (in the opposite direction to the wall X in FIG. 7).

Also, the operation of the first door 211 through the linear motor 310 and the operation of the second door 213 through the second door driving module 320 can be changed in their time and ways.

For example, a first door control event in which the linear motor 310 slides the first door 211 on the accommodation space 130 and a second door control event in which the second door driving module 320 slides the second door 213 on the first door 211 can occur simultaneously, and otherwise, one of the first door control event and the second door control event can occur before the other control event occurs.

When the opening and closing part 200 is open and closed, in detail, the linear motor 310 and the second door driving module 320 can slide the first door 211 and the second door 213 simultaneously, and otherwise, the linear motor 310 and the second door driving module 320 can slide the first door 211 and the second door 213 at a given time interval. In detail, the linear motor 310 first slides the first door 211 before the second door driving module 320 slides the second door 213, and otherwise, the second door driving module 320 first slides the second door 213 before the linear motor 310 slides the first door 211.

According to the present invention, the time and speed for sliding the first door 211 through the linear motor 310 are set differently from those for sliding the second door 213 through the second door driving module 320, thereby increasing variety in opening and closing ways and providing the access control apparatus 1 having an excellent design.

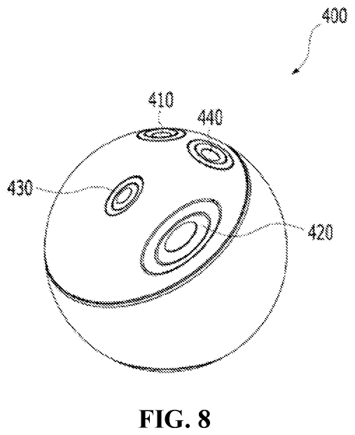

FIG. 8 is a perspective view showing a detailed configuration of the recognizing part 400 of the access control apparatus according to the present invention, and the recognizing part 400 will be in detail explained with reference to the above-mentioned description and FIG. 8.

The access control apparatus 1 can admit access to access-admitted persons through the recognizing part 400. The recognizing part 400 includes at least one or more modules selected from a finger print recognizing module 410 for recognizing the finger print of the user of the access control apparatus 1, a vein recognizing module 420 for recognizing the vein shape of the user of the access control apparatus 1, an iris recognizing module 430 for recognizing the iris of the user of the access control apparatus 1, and a face recognizing module 440 for recognizing the facial shape of the user of the access control apparatus 1.

The recognizing part 400 can recognize the user of the access control apparatus 1 through only one of the four recognizing modules 410, 420, 430 and 440, but if it is necessary to enhance a security level, the recognizing part 400 recognizes the user of the access control apparatus 1 through all of the four recognizing modules 410, 420, 430 and 440.

Further, the recognizing part 400 further includes a storage (not shown) or user register (not shown) having a database form in which user information having at least one or more pieces of information selected from finger print, vein, iris, and face information of the user is stored.

The recognizing part 400 compares user information in advance stored in the storage (not shown) or the user register (not shown) with the user's finger print, vein shape, iris, and facial shape recognized through the respective modules 410, 420, 430 and 440, and if the user information corresponds to the recognized user information, the access control apparatus 1 can change the opening and closing part 200 to the opening mode through the driving part 300. Contrarily, if not, the access control apparatus 1 can keep the opening and closing part 200 to the closing mode through the driving part 300.

In addition, if the user information does not correspond to the recognized user information through the recognizing part 400, the access control apparatus 1 can provide predetermined sounds through the speaker (not shown). For example, if the user information does not correspond to the recognized user information through the recognizing part 400, the access control apparatus 1 can provide sounds like “You are not admitted” or “Please let me recognize you again” through the speaker (not shown).

Further, the respective modules 410, 420, 430 and 440 can sense the finger print, the vein shape, the iris, and the facial shape to be recognized through an optical method using cameras. At this time, the respective modules 410, 420, 430 and 440 are close to each other so that the access control apparatus 1 can enhance a user recognizing efficiency.

Furthermore, if the recognizing part 400 has a shape of a ball or column, the respective modules 410, 420, 430 and 440 are located at the hollow interior of the recognizing part 400, and a housing made of a transparent material like glass is mounted on the outer periphery of the recognizing part 400.

Also, the recognizing part 400 can perform the recognition for the finger print or vein shape of the user even if the user's body does not come into direct contact therewith, and further, the recognizing part 400 can perform the recognition for the facial shape or iris shape of the user even while the user is accessing thereto.

The user information recognized or acquired by the recognizing part 400 can be called user biological data having at least one of the finger print, vein, iris, and facial shapes of the user. The respective modules 410, 420, 430 and 440 can recognize or acquire the user biological data sensible thereby, independently of each other.

If the recognizing part 400 includes all of the modules 410, 420, 430 and 440, the access control apparatus 1 can open the opening and closing part 200 even in a case where a portion of the user biological data sensed by the modules 410, 420, 430 and 440 is recognized. For example, even if only the finger print sensing through the finger print recognizing module 410 is finished, the access control apparatus 1 can open the opening and closing part 200. Accordingly, the recognizing speed of the recognizing part 400 can be increased, and also, the driving speed for opening and closing the access control apparatus 1 can be raised.

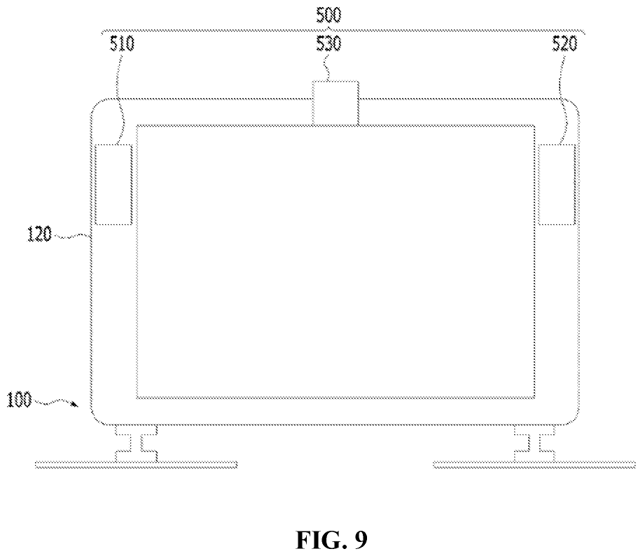

FIG. 9 is a side view showing a detailed configuration of the guiding part 500 of the access control apparatus according to the present invention.

The guiding part 500 serves to sense users of the access control apparatus 1. If a plurality of users is sensed, further, the guiding part 500 performs access guiding to the access control apparatus 1 for the users, thereby improving the user's conveniences in use.

In detail, the guiding part 500 includes a first sensing module 510 disposed on one end of the body 1, a second sensing module 520 disposed on the other end of the body 1, and an access guiding module 530. The first sensing module 510 and the second sensing module 520 are located on the access control apparatus 1, but of course, they may be located on positions separated from the access control apparatus 1.

The access control apparatus 1 is installed on the passage to control the access to the passage, and in this case, generally, the user can be accessed to two ways of the access control apparatus 1. Accordingly, the first sensing module 510 and the second sensing module 520 are located symmetrically to each other on both ends of the support frames 120 around the support frames 120.

One or more access guiding modules 530 may be located on the access control apparatus 1. For example, if two access guiding modules 530 are located on the access control apparatus 1, they are located at the positions close to the first sensing module 510 and the second sensing module 520 so as to guide the two-way users.

The first sensing module 510 serves to sense one side user of the access control apparatus 1 to measure a distance from the sensed user. The second sensing module 520 serves to sense the other side user of the access control apparatus 1 to measure a distance from the sensed user.

If any one of the first sensing module 510 and the second sensing module 520 senses the user, after that, the guiding part 500 can guide the sensed user to the access control apparatus 1 through the access guiding module 530. If both of the first sensing module 510 and the second sensing module 520 sense the users, further, the guiding part 500 can guide the first sensed user in the sensed order to the access control apparatus 1 through the access guiding module 530, and otherwise, the guiding part 500 can guide the closer user on the basis of the sensed distance to the access control apparatus 1 through the access guiding module 530.

In detail, the guiding part 500 performs access guiding for the sensed users according to various standards like the sensed order or distance and also guides the plurality of users to different ways.

Further, the guiding part 500 compares a distance from one side user measured through the first sensing module 510 with a distance from the other side user measured through the second sensing module 520 and guides one side user and the other side user to the access control apparatus 1 through the access guiding module 530. At this time, the access guiding module 530 can provide first access to the access control apparatus 1 for one side user or the other side user by means of lighting of LEDs. The access guiding module 530 does not have any limitations in a method and form in lighting the LEDs.

For example, if it is desired that the plurality of users simultaneously accesses to the access control apparatus 1, the first sensing module 510 and the second sensing module 520 mounted at the symmetrical positions of the access control apparatus 1 sense the users located at their respective positions and measure the distances from the users.

After that, the guiding part 500 compares the distance measured through the first sensing module 510 with the distance measured through the second sensing module 520, and the guiding part 500 thus guides the user located at the closer distance by displaying the LEDs indicating an arrow mark or a phrase “allowed” through the access guiding module 530, while guiding the user located at a relatively long distance by displaying the LEDs indicating an X mark or a phrase “not allowed” or “Please wait for a while” through the access guiding module 530.

As a result, the access control apparatus 1 can increase the user conveniences and prevent collision between the plurality of users and the access control apparatus 1 when the plurality of users simultaneously access thereto.

Referring back to FIG. 2, as mentioned above, the access control apparatus 1 further includes the measuring part 600 for the number of users thereof, the communication part 700 for transmitting and receiving the information related thereto to and from a predetermined terminal, and a controller 900 for monitoring the information related thereto.

The measuring part 600 for the number of users and the communication part 700 are also located on the access control apparatus 1.

The communication part 700 is interlocked with the predetermined terminal wirelessly and transmits the information related to at least one or more parts of the body 100, the opening and closing part 200, the driving part 300, the recognizing part 400, the guiding part 500, the measuring part 600 for the number of users, and the communication part 700 to the predetermined terminal.

The communication part 700 makes use of wireless communication technology when it transmits the information. For example, the communication part 700 makes use of wireless communication technology such as Bluetooth, Zigbee, LTE, and Wi-Fi, but of course, it is not limited thereto.

The predetermined terminal is a communicable digital device. For example, the predetermined terminal includes a smart phone, a smart pad, a smart glass, a smart winch, a laptop, a computer, or PDA, but of course, it is not limited thereto.

The measuring part 600 for the number of users measures the number of users of the access control apparatus 1 through at least one or more information selected from information on the number of driving times of the opening and closing part 200, information on the number of times changed into the folded and unfolded structures of the folding arm 210, information on the number of times for the user recognition of the recognizing part 400, and information on the number of times for user access guiding of the guiding part 500. Also, the measuring part 600 for the number of users can measure the number of users according to given standards like the number of users for a day, the number of users during specific time.

The information transmitted from the communication part 700 to the predetermined terminal includes at least one or more information selected from error information related to at least one or more parts of the body 100, the opening and closing part 200, the driving part 300, the recognizing part 400, the guiding part 500, the measuring part 600 for the number of users, and the communication part 700, information on the number of driving times of the opening and closing part 200, information on the number of times changed into the folded and unfolded structures of the folding arm 210, information on the number of times for the user recognition of the recognizing part 400, information on the number of times for user access guiding of the guiding part 500, and information on the number of users of the access control apparatus 1 measured by the measuring part 600.

The controller 900 serves to display the information related to the access control apparatus 1 by means of a display module (not shown). Further, the controller 900 serves to monitor the information related to the access control apparatus 1 by means of separate software or to change setting of the respective parts of the access control apparatus 1.

For example, the controller 900 performs mode changes of the opening and closing part 200, recognition method setting and changes of the recognizing part 400, guiding method setting and changes of the guiding part 500, information transmission to the predetermined terminal through the communication part 700, sound setting and changes of the speaker (not shown), and error information acquisition and display of the respective parts of the access control apparatus 1.

Through the information transmission and reception of the communication part 700, the predetermined terminal can perform analysis, management and error analysis of the information related to the access control apparatus 1. Through control software of the access control apparatus 1 stored in the predetermined terminal, further, the access control apparatus 1 can be repaired or managed remotely. Even if the access control apparatus 1 is not disassembled, also, the controller 900 can change the setting of the access control apparatus 1 and monitor the access control apparatus 1. Accordingly, conveniences for the manager of the access control apparatus 1 can be improved.

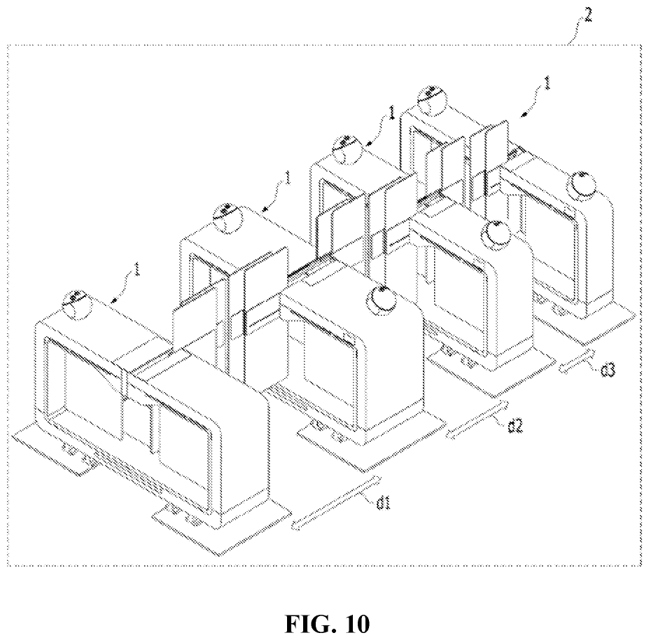

FIG. 10 is a perspective view showing an access control system 2 having the plurality of access control apparatuses 1 according to the present invention, and the access control system 2 will be in detail explained with reference to FIGS. 2 to 10.

The access control system 2 has the plurality of access control apparatuses 1 spaced apart from each other by a given distance so as to form respective passages, and the access control apparatuses 1 may be paired two of each with each other in such a manner as to face each other.

Also, the access control system 2 controls the sliding length of the first door 211 on the accommodation space 130 of each access control apparatus 1 and the sliding length of the second door 213 on the first door 211 of each access control apparatus 1, thereby adjusting the given distance between the access control apparatuses 1.

When various widths d1, d2 and d3 of the access control system 2 as shown in FIG. 10 are compared with each other, the width d1 is the largest width among the widths d1, d2 and d3 of the access control system 2 having the plurality of access control apparatuses 1, the width d2 is smaller than the width d1 but larger than the width d3, and the width d3 is the smallest width among the widths d1, d2 and d3.

If the installation widths of the plurality of access control apparatuses 1 are freely set to constitute the access control system 2, a reinstallation cost of the access control apparatuses 1 can be reduced, and spatial utility can be enhanced.

If the opening and closing parts 200 and the driving parts 300 are located on both surfaces of the support frame 120 and the recognizing parts 400 are located in two directions of the access control apparatus 1, as mentioned above, spatial utility of the access control system 2 can be enhanced.

The functions of the above-mentioned access control apparatus 1 and the access control system 2 can be carried out by means of external power or batteries built therein. Further, the respective parts of the access control apparatus 1 can be connected or interlocked with each other wiredly or wirelessly, and the functions of the respective parts can be controlled, independently of each other. However, they are not necessarily controlled, independently of each other, and of course, they are controlled in such a manner as to be physically or electrically dependent on each other.

If the access control apparatus 1 is used, the sliding length of the first door 211 on the accommodation space 130 and the sliding length of the second door 213 on the first door 211 can be set, independently of each other, by means of the opening and closing part 200 having the multi-stepped door 210 doubly slidable.

When compared with the conventional slide type gate wherein the passage is open and closed through the door having a predetermined size, the access control apparatus 1 according to the present invention can reduce the width of the support frame 120, so that the access control system 2 having the plurality of access control apparatuses 1 can be reduced in an installation width thereof.

If the installation width of the access control system 2 is reduced, the number of access control apparatuses 1 constituting the access control system 2 is increased in a restricted space, so that the number of users using the access control system 2 within predetermined time can be increased, thereby resulting in the increment in a handling capacity as a standard for estimating the performance of the access control system 2.

According to the present invention, further, the access control apparatus 1 can control the operation of the opening and closing part 200 by means of the driving part 300 not having the rotary motor but having the linear motor 310, thereby increasing the driving speed, that is, the opening and closing speed of the opening and closing part 200 and improving the durability of the access control apparatus 1 as well as the access control system 2. If the durability of the access control apparatus 1 is increased, the reliability and economical effects of the access control apparatus 1 can be also improved.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention. It should be therefore understood that the embodiments of the present invention are just exemplary embodiments, while not limiting the present invention. For example, the parts expressed in a singular form may be dispersedly provided, and in the same manner as above, the parts dispersed may be combined with each other. The present invention may be modified in various ways and may have several exemplary embodiments. Specific exemplary embodiments of the present invention are illustrated in the drawings and described in detail in the detailed description. However, this does not limit the invention within specific embodiments and it should be understood that the invention covers all the modifications, equivalents, and replacements within the idea and technical scope of the invention.

1. An access control apparatus comprising:
a body located on a passage;
an opening and closing part coupled to the body and having a multi-stepped door adapted to open and close the passage through a translational motion; and
a driving part coupled to the body and the opening and closing part to control an operation of the opening and closing part,
wherein the driving part has a linear motor and the multi-stepped door comprises a first door driven by means of the linear motor and a second door coupled to the first door in such a manner as to be interlocked with the first door.

2. The access control apparatus according to claim 1, wherein the body comprises a support frame having an accommodation space adapted to allow the opening and closing part and the driving part to be detachably attached or inserted thereinto.

3. The access control apparatus according to claim 2, wherein the opening and closing part and the driving part are coupled to each other to constitute an integral type unit, and the integral type unit is inserted into the accommodation space.

4. The access control apparatus according to claim 3, wherein a plurality of integral type units is provided.

5. The access control apparatus according to claim 2, wherein the linear motor controls the first door so that the first door slides on the accommodation space.

6. The access control apparatus according to claim 5, wherein the driving part further comprises a second door driving module for surrounding the second door to control the second door so that the second door slides on the first door.

7. The access control apparatus according to claim 6, wherein the second door driving module comprises a power transmission unit and slides the second door on the first door through the power transmission unit.

8. The access control apparatus according to claim 6, wherein if the opening and closing part is closed by means of the driving part, the linear motor controls the first door in such a manner as to allow the first door to slide toward the outside of the accommodation space, while the second door driving module is controlling the second door in such a manner as to allow the second door to slide toward the outside of the first door, and if the opening and closing part is open by means of the driving part, the linear motor controls the first door in such a manner as to allow the first door to slide toward the inside of the accommodation space, while the second door driving module is controlling the second door in such a manner as to allow the second door to slide toward the inside of the first door.

9. The access control apparatus according to claim 8, wherein a first door control event in which the linear motor slides the first door on the accommodation space and a second door control event in which the second door driving module slides the second door on the first door occur simultaneously, and otherwise, one of the first door control event and the second door control event occurs before the other control event occurs.

10. The access control apparatus according to claim 1, further comprising a recognizing part located on one side thereof and having at least one or more modules selected from a finger print recognizing module for recognizing the finger print of the user of the access control apparatus, a vein recognizing module for recognizing the vein shape of the user of the access control apparatus, an iris recognizing module for recognizing the iris of the user of the access control apparatus, and a face recognizing module for recognizing the facial shape of the user of the access control apparatus so as to recognize the user of the access control apparatus, so that if the recognized user of the access control apparatus is an access-admitted person, the access control apparatus opens the opening and closing part by means of the driving part.

11. The access control apparatus according to claim 2, further comprising a guiding part adapted to guide the use of the access control apparatus and having a first sensing module disposed on one end of the support frame to sense one user of the access control apparatus, a second sensing module disposed on the other end of the support frame symmetrical to one end of the support frame to sense the other user of the access control apparatus, and an access guiding module for guiding access to the access control apparatus, so that if any one of the first sensing module and the second sensing module senses one user, the guiding part guides the sensed user to the access control apparatus through the access guiding module, and if both of the first sensing module and the second sensing module sense the users, the guiding part guides the first sensed user in the sensed order to the access control apparatus through the access guiding module or guides the closer user on the basis of the sensed distance to the access control apparatus through the access guiding module.

12. The access control apparatus according to claim 11, wherein the access guiding module provides first access to the access control apparatus for one user or the other user by means of lighting of LEDs toward one user or the other user or guide one user and the other user to different ways.

13. An access control system comprising a plurality of access control apparatuses according to claim 1, wherein the plurality of access control apparatuses is spaced apart from each other by given distances.
